(19) United States
(12) Patent Application Publication
(10) Pub. No.: US 2026/0157383 A1
(43) Pub. Date: Jun. 11, 2026

(54) SMOKER BOX AND ITS ACCESSORIES FOR A BARBECUE

(71) Applicant: Helge Keben, Fredericksburg, VA (US)

(72) Inventor: Helge Keben, Fredericksburg, VA (US)

(21) Appl. No.: 18/975,437

(22) Filed: Dec. 10, 2024

(51) Int. Cl. A23B 4/052; A47J 37/07

(52) U.S. Cl. CPC A23B 4/0523; A47J 37/0786

(57) ABSTRACT

The invention generally relates to outdoor cooking devices and, more particularly, smoker box accessories. The invention solves the problem of smoke auto-ignition when using a smoker box in a normal gas and charcoal grill. The smoke box can be of a size to reach one burner or several, which allows you to extend the smoking time by using one burner at a time. There is no need to soak the wood chips beforehand and the bluish smoke develops without delay. The solution is suitable for all grills and can also be used on the adjacent gas burner of the cooker and lead the smoke to the grill for cold smoking.

The present disclosure relates generally to outdoor cooking devices and, more particularly, to smoker box accessories.

### BACKGROUND OF THE INVENTION

Outdoor grilling is a popular cooking method, with most modern grills powered by gas or charcoal. While these methods provide convenience and consistent heat, they often lack the nuanced flavors imparted by burning hardwoods. Various devices have been developed to infuse grilled foods with smoke by burning wood chips, chunks, or pellets to address this in standard barbecue. Traditional methods of using wood chips such as constructing makeshift aluminum foil pouches or utilizing commercially available metallic containers face several limitations. These include inadequate heat for producing sufficient smoke when the container or pouch is placed on the grilling surface. The risk of auto-ignition into flames is big when the container or pouch is placed on a heat source like a gas burner. These burners are horizontal round tubes with small holes for the gas to come out and burn. Auto-ignition into flames is attempted to be prevented by soaking the smoke-producing wood beforehand resulting in water vapor and not proper smoke causing inefficiencies in achieving desired smoke production and penetration anyway quite soon you see flames and soaking wood pellets break them into sawdust.

Existing innovations have sought to resolve the challenges with varying success:
Direct Contact Smokers: Some designs place smoker attachments directly on heat sources like gas burners or charcoal, ensuring adequate heat for smoke production. However, these methods result in excessive heat ignition into flames, overconsuming wood chips, and overcooking food before proper smoke infusion occurs.
Reusable and Disposable Containers: Devices like perforated cartridges or vented boxes aim to regulate airflow and prevent flaming while facilitating smoke generation. Despite these improvements, challenges persist in achieving consistent smoke production without a high risk of ignition into flames.
Specialized Shapes and Configurations: such as triangular or cylindrical designs, provide innovative means of integrating smoker attachments into grills. Unfortunately, it is always just a matter of time before the smoke ignites, the smoke decreases and the heat in the grill increases burning the food because the desired cooking temperature is usually below 300 F which will quickly be exceeded after the flaming of the wood or outcoming smoke depending on the solution.

All the existing solutions to add a smoker box to a normal barbecue have one fundamental fault. They either do not produce smoke when placed on the grilling surface because the temperature is not high enough or the outcoming smoke ignites in open flames if the smoker box is placed on the burners. The reason is that the hot rising air from the burners and/or hot surface of the smoker box will ignite the smoke at the openings of the smoker box because the openings are in a too-hot place. There are instructions on the internet on how to soak wood chips for at least 30 minutes before use to prevent them from catching fire. Use of wet wood results in water vapor and non-proper smoke causing inefficiencies in achieving desired smoke penetration. Wet wood doesn't produce the desired bluish smoke, but water vapor, and anyway quite soon the wood or outcoming smoke depending on the solution starts burning in flames.

The next paragraph tells the root cause of the problems in the existing solutions.

### SCIENTIFIC BACKGROUND FOR THE INVENTION

Smoke is only produced in incomplete combustion. Smoking wood produces carbon monoxide, carbon dioxide, and gas from heated cellulose, hemicellulose, and lignin. This gas mixture has its typical auto-ignition temperature under normal conditions. If the surface of the smoker box at the smoke outlet opening or the ambient temperature at the smoke outlet opening exceeds the auto-ignition temperature and oxygen is available, the gas mixture will catch fire, only a little smoke will be produced, the temperature will rise, and the food will burn. The wood in the smoker box doesn't get fire but the outcoming smoke does.

### BRIEF SUMMARY OF INVENTION

The object of the present invention is to eliminate the drawbacks mentioned above of the existing solutions and develop an affordable solution for smoking food. It provides an efficient, reliable, easy-to-use smoker box solution that can be used in gas and charcoal barbecues. It can be used both inside the grill and the adjacent gas burner of the cooker and it doesn't require soaking of the wood material beforehand.

The invention is characterized by what is outlined in the characterizing part of claim 1. Other embodiments of the invention are characterized by what is stated in the other claims.

The smoker box works well if the wood can be dry and when the smoker box is heated sufficiently the wood starts to char and smoke shortly. The airflow through the smoker box must be sufficient to avoid dry distillation and to produce a lot of smoke to give food a smoky flavor and shorten the required smoking time. The gas burns cleanly in the barbecue and does not spark to ignite the smoker. In this solution, the bottom of the smoker box is on or near the top of the burners and the smoke outlet opening is above the burners but the air inlet opening is not. The surface of the smoker box at the smoke outlet opening and the ambient temperature are below the auto-ignition temperature of the out-coming smoke to prevent the smoke from igniting into open flames.

### BRIEF DESCRIPTION OF THE SEVERAL VIEWS OF THE DRAWINGS

In the following, the invention will be described in more detail with reference to the accompanying simplified drawings, in which

FIG. 1—shows smoker box 3 according to one embodiment.

FIG. 2—shows smoker box 3 according to another embodiment.

FIG. 3—shows smoker box 3 according to another embodiment.

FIG. 4—shows smoker box 3 according to another embodiment in which the only openings are the air inlet opening 3f and the smoke outlet opening 3h which are to be used also for filling and emptying smoker box 3.

FIG. 5—shows smoker box 3 in FIG. 4 viewed from left.

FIG. 6—shows a barbecue with smoker box 3 on gas burner 7, under lid 1 within a barbecue according to one embodiment, viewed from the left when using the barbecue.

FIG. 7—shows the barbecue with a smoker box 3 on gas burner 7, under lid 1, cut from 1-1 in FIG. 4.

FIG. 8—shows a barbecue with smoker box 3 on gas burner 7, under lid 1 according to another embodiment, viewed from the left when using the barbecue.

FIG. 9—shows the barbecue with a smoker box 3 on gas burner 7, under lid 1, cut from 2-2 in FIG. 6.

FIG. 10—shows ventilation shutter plate 14 according to one embodiment viewed from the front in FIG. 17.

FIG. 11—shows ventilation shutter plate 14 according to one embodiment viewed from the front in FIG. 16.

FIG. 12—shows ventilation shutter plate 15 according to one embodiment viewed from the front in FIG. 17.

FIG. 13—shows ventilation shutter plate 15 according to one embodiment, viewed from the front in FIG. 16.

FIG. 14—shows frying plate 16 according to one embodiment viewed from the front in FIG. 17.

FIG. 15—shows frying plate 16 according to one embodiment viewed from above in FIG. 12.

FIG. 16—shows frying plate 16 and frying grille 17 according to one embodiment viewed from the front in FIG. 17.

FIG. 17—shows frying plate 16 and frying grille 17 according to one embodiment viewed from above in FIG. 14.

FIG. 18—shows the barbecue with smoker box 3 on the adjacent gas burner of cooker 18, and accessories 14, 15, 16, and 17 of smoker box 3 according to one embodiment, viewed from the left when using the barbecue.

FIG. 19—shows the barbecue with a smoker box 3 on the adjacent gas burner of cooker 18 and accessories 14, 15, 16, and 17 of smoker box 3, cut from 3 -3 in FIG. 16.

### DETAILED DESCRIPTION OF THE INVENTION

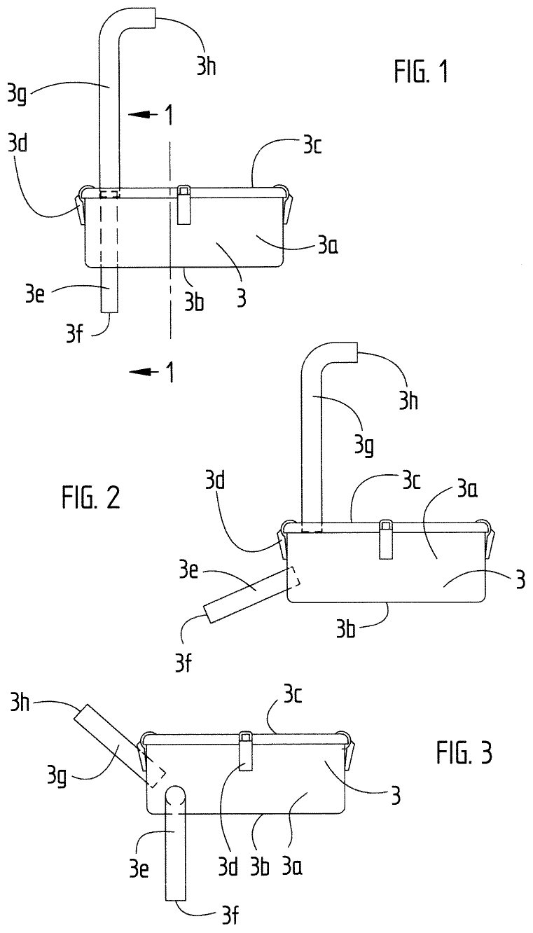

FIGS. 1, 2, and 3 illustrate three embodiments of smoker box 3 which consists of the following parts:

3a is the container for wood which will be charred to produce smoke, 3b is the bottom of smoker box 3, 3c is the cover of smoker box 3, 3d are the latches to lock cover 3c to container 3a, 3e is the part where air passes without leakage into the closed smoker box 3, and point 3f having its edges is the air inlet opening in part 3e where the air passes without leakage into part 3e, 3g is the part where air exits without leakage the closed smoker box 3 and point 3h having its edges is the smoke outlet opening in part 3g where smoke exits without leakage the closed smoker box 3. Part 3e is fixed to container 3a and part 3g is fixed to cover 3c, which are parts of smoker box 3. Thus, the air inlet opening 3f and smoke outlet opening 3h are connected to smoker box 3 and they are the essential points of smoker box 3.

Smoker box 3 will be filled in the following way:

Cover 3c with part 3g will be removed and the bottom 3b of smoker box 3 will be covered with a thin layer of wood 9, more precisely dry wood chips, chunks, or pellets. Cover 3c is put back on container 3a and secured by latches 3d, which close the gap between container 3a and cover 3c. Part 3e can be a removable or fixed part of container 3a or its protrusion and/or part 3g can be removable or a fixed part of cover 3c or its protrusion. Smoker box 3 has one smoke outlet opening 3h and when smoker box 3 is used on burner 7 the smoke outlet opening 3h is at the highest level of all parts of smoker box 3.

If smoker box 3 is next to burner 7 and the hot air or fire from burner 7 doesn't go under bottom 3b of smoker box 3, the wood doesn't start smoking.

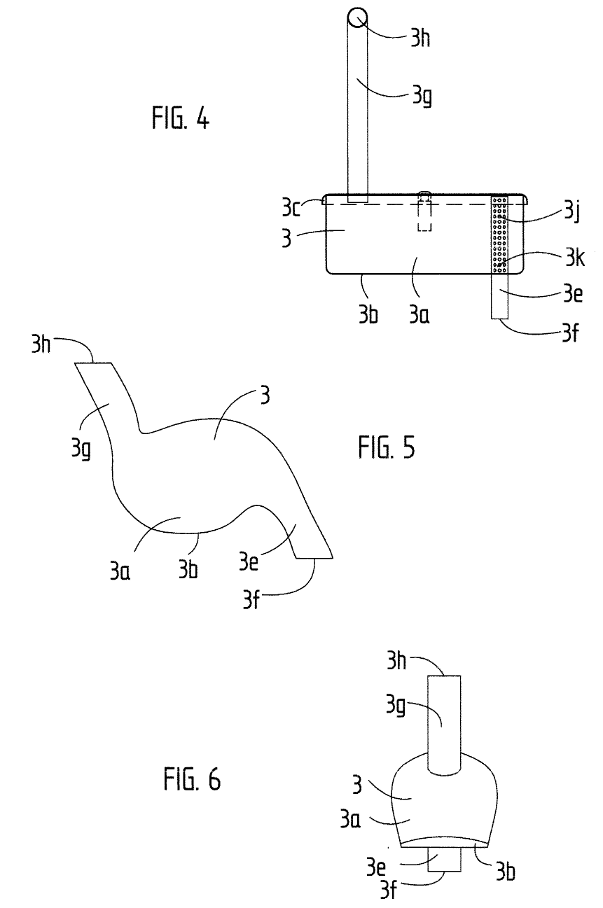

FIGS. 4 and 5 illustrate one more embodiment of smoker box 3 which is best suited especially for wood pellets, which will be charred to produce smoke.

This embodiment consists of the following parts:

3a is the container, 3b is the bottom of smoker box 3, 3e is the part where air passes without leakage into the closed smoker box 3, and point 3f having its edges is the air inlet opening in part 3e where the air passes without leakage into part 3e, 3g is the part where air exits without leakage the closed smoker box 3 and point 3h having its edges is the smoke outlet opening in part 3g where smoke exits without leakage the closed smoker box 3. Bottom 3b is round in FIG. 4 but flat in FIG. 5. The round bottom 3b helps in finding the best position for smoker box 3 to have the air inlet opening 3f in the ventilation opening 8 and the flat bottom 3d in the opposite direction keeps smoker box 3 standing upright but bottom 3b can be round in both directions. Cooking grate 5 located on the adjacent grate 5 can support smoker box 3. The “tail half” of smoke box 3 is also heavier than the “head half” of smoke box 3 which can be called a “Smoke Bird”. Parts 3e and 3g are fixed to container 3a. The air inlet opening 3f and smoke outlet opening 3h are connected to smoker box 3 and they are the essential points of smoker box 3. The only openings are the air inlet opening 3f and the smoke outlet opening 3h which are to be used also for filling and emptying smoker box 3.

Parts 3e and 3g can be removable or permanently fixed parts of smoker box 3. This kind of smoker box 3 can be made for example of two deep-drawn metal halves which will be fixed together. The halves are all of one sheet part forming container 3a and hollow protrusions 3e and 3g. The shape of smoker box 3 can vary. The air inlet opening 3f must be at least 1 inch below the bottom 3b of container 3a to reach the ventilation opening 8. It is desirable that the smoke outlet opening 3h is above cooking grill 5 to ensure a good draft.

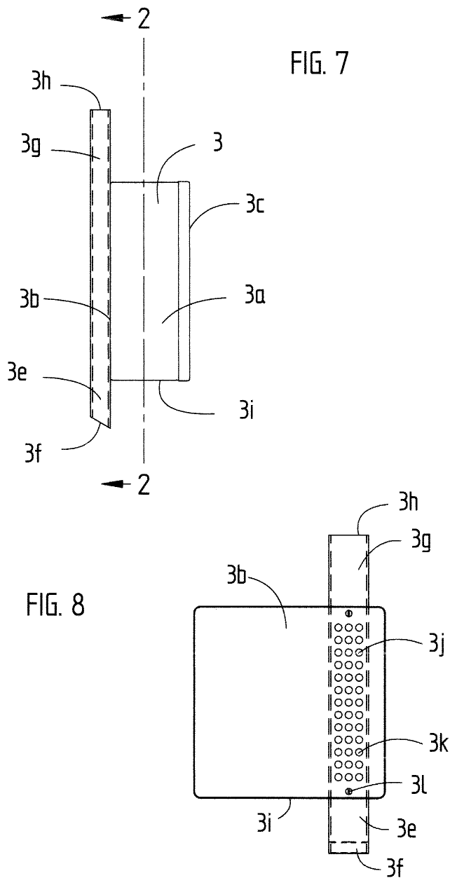

FIGS. 6 and 7 illustrate how smoker box 3 in FIG. 1 or FIG. 4 filled with wood 9 is used to convert a normal gas grill into a temporary or even permanent smoker. Section 1a is part of lid 1 and section 10a is part of body 10 of the barbecue. Lid 1 of the barbecue is first raised to the top position. Cooking grate 5 and baffler 13 next to hole 6, will be removed. Smoker box 3 will be placed on or near the top of burner 7 so that part 3e having the air inlet opening 3f is placed in ventilation opening 8 next to the left side wall of the barbecue. Cooking grate 5 will be put back and the food to be prepared will be placed on cooking grate 5 in the middle of the grilling area.

The gas tap will be opened, burner 7 under smoker box 3 will be ignited, gas will be turned to the maximum by knob 11, and lid 1 will be lowered. For faster heating to the desired temperature, the adjacent burner 7 can also be used. Smoking starts soon because bottom 3b of smoker box 3 gets very hot, wood 9 is dry and when the desired temperature is reached the amount of gas is reduced to a suitable level by knobs 11. The bottom 3b of smoker box 3, against burner 7, is its hottest place. Heat is transferred from there to the environment by airflow, and radiation especially from burner 7, and also by conduction in the parts of smoker box 3. The smoke comes out from the smoke outlet opening 3h of smoker box 3 at a sufficient height from the hot bottom of smoker box 3 and the air inlet opening 3f. The smoke outlet opening 3h has its edges limiting the cross-area of it. These edges are connected to cover 3c. Also, the air inlet opening 3f has its edges limiting the cross-area of it. These edges are connected to container 3a. In this solution, the smoke comes out from smoker box 3 from a point where the temperature of both the edges of the smoke outlet opening 3h and the ambient temperature are below the auto-ignition temperature of the smoke. In this place, the edges of the smoke outlet opening 3h are at the highest level of all parts of smoker box 3. The smoke outlet opening 3h is located above cooking grate 5 and the smoke is directed towards the front of the barbecue, as most of the holes for the smoke exit are at the back of the barbecue.

Air is taken in through the air inlet opening 3f of smoker box 3 sufficiently low from bottom 3b of smoker box 3 and the smoke outlet opening 3h. The barbecue has next to its walls, located lower than the burners, the ventilation opening 8, which brings fresh air to the gas combustion of the burners 7. The air is taken into smoker box 3 at a place where the temperature of the edges of the air inlet opening 3f and the ambient temperature are below the auto-ignition temperature of the smoke. A good place for the air inlet opening 3f is lower than burner 7 in ventilation opening 8. There the air inlet opening 3f and the edges of the air inlet opening 3f are lower than the lowest point of the burner 7. An alternative place is just above the ventilation opening 8, next to the vertical walls of the barbecue. Charcoal barbecues have also a ventilation opening and the air inlet opening 3f can be located there, lower than the charcoals. In some designs, in the charcoal barbecues the air inlet opening 3f can be located below the charcoal grate. At its highest level, the air inlet opening 3f can be within the vertical range of burner 7 when the air inlet opening 3f is directly above ventilation opening 8. In this place, the air inlet opening 3f and its edges are located lower than the highest point of burner 7. In principle, the airflow is from the air inlet opening 3f into the smoker box 3, but it is safest to take the air to smoker box 3 in ventilation opening 8 or directly above it, where cooler air is available. This arrangement provides sufficient draft in the smoker box, like in a chimney, and smoke does not come out of the air inlet opening 3f. The tests show that even if the draft in smoke box 3 is good the edges of the air inlet opening 3f shall be lower than the highest point of burner 7. It helps when smoke box 3 is longer having several burners 7 under it, the air inlet opening 3f is next to the side wall of the barbecue, and the nearest burner 7 is not used. When using a long smoker box 3, not all air inlet openings 3f need to be below burners 7, but when used far from a hot burner 7, the air inlet opening 3f can also be on a higher level than burner 7. Similarly, when using a long smoke box, not all smoke outlet openings 3h need to be at the top of the smoke box. If the smoker box doesn't have any air inlet opening but only one small smoke outlet opening 3h, it is a dry distillation which we don't want. Therefore, we need sufficient airflow through smoker box 3 to produce a lot of smoke, but not excessively large airflow so that the wood does not ignite inside the smoker box burning like in open air, but only starts charring. The temperature of the surface of smoker box 3 at a smoke outlet opening 3h and the ambient temperature shall be below the auto-ignition temperature of the outcoming smoke to prevent the smoke from igniting into open flames when oxygen is available outside smoker box 3. Once we have ensured sufficient airflow inside the smoker box, the air inlet opening 3f can be in a slightly hotter location because the smoke will not come out of the air inlet opening 3f. The air inlet opening 3f should be slightly smaller than the smoke outlet opening 3h so that the air speed is sufficient to ensure flow only inwards to smoker box 3. This solution is also suitable for a charcoal barbecue by taking air through the hole below the charcoals using the longer part 3e through the air inlet opening 3f below the charcoals.

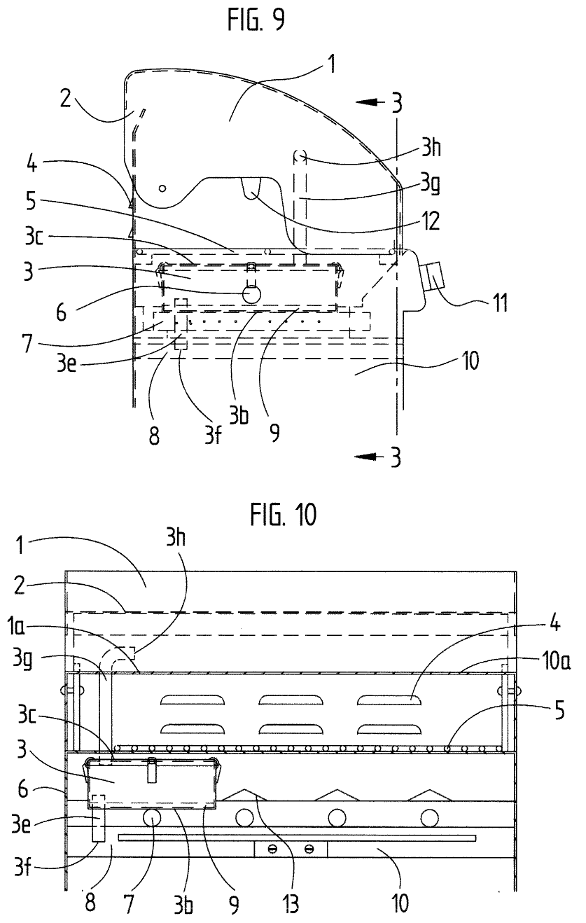

FIGS. 8 and 9 illustrate how smoker box 3 in FIG. 2 filled with wood 9 is placed in the barbecue. Smoker box 3 will be placed on or near the top of burner 7 so that part 3e having the air inlet opening 3f goes through hole 6 in the side wall of the barbecue. This hole 6 is available for igniting the adjacent burner 7 if the piezo ignitor doesn't work. The air inlet opening 3f is outside of the barbecue in a cooler place and it can be located lower than burner 7, avoiding auto-ignition of the smoke and creating a good draft in smoker box 3. The air goes to smoker box 3 through hole 6 in the sidewall of the barbecue, available for igniting the adjacent burner 7. Outlet opening 3h is high above burner 7 avoiding auto-ignition of the outcoming smoke. This embodiment suits well to charcoal barbecue in which smoker box 3 will be placed on or near the barbecue charcoal.

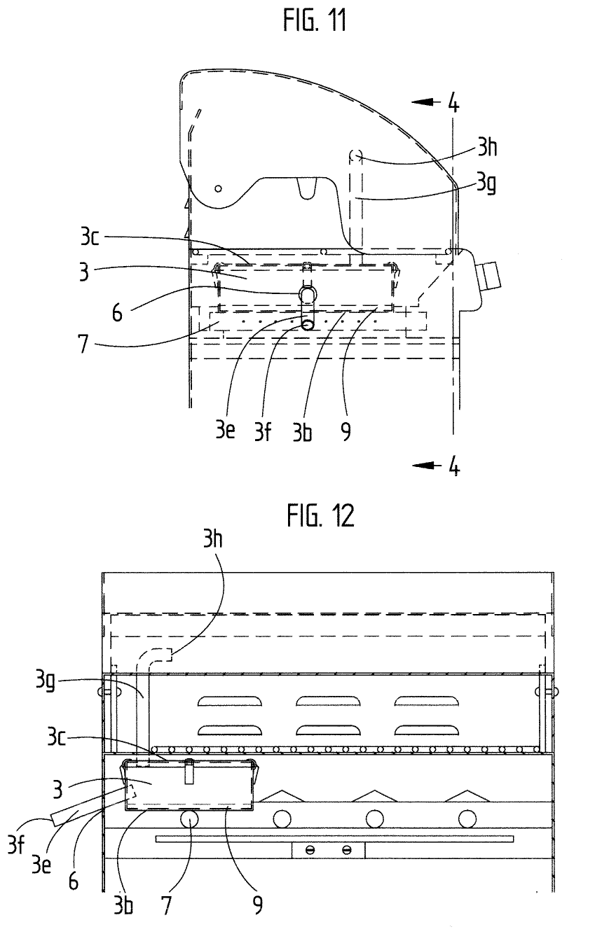

FIGS. 10 and 11 illustrate ventilation shutter 14 which can be used to reduce ventilation in air gap 2 to thicken the smoke within the barbecue. Shutter 14 has groove 14a for quick fastening around the inclined part of the back plate of body 10 of the barbecue. Sheet 14b is flexible to follow the inner surface of lid 1 when lid 1 is lowered.

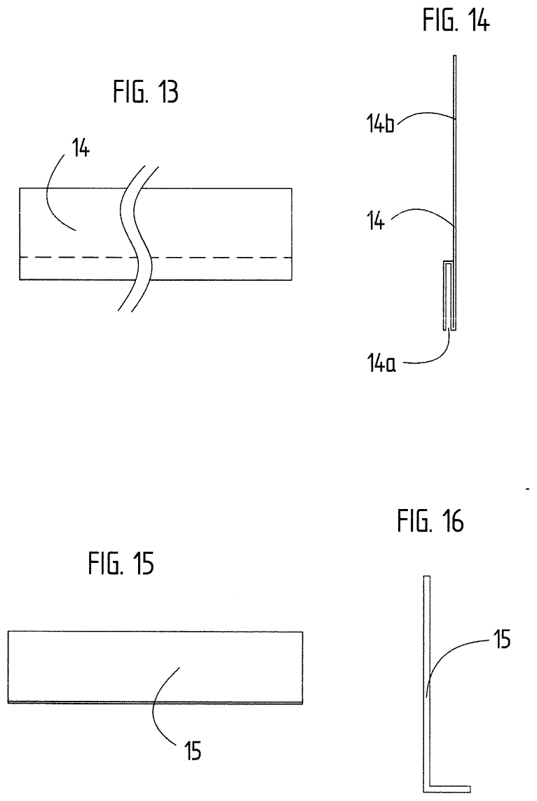

FIGS. 12 and 13 illustrate ventilation shutter 15 which can be used to cover ventilation holes 4 to thicken the smoke within the barbecue.

It is possible to reduce the ventilation because the desired smoking temperature is low and therefore use of only one burner is enough. The barbecue has a lot of holes for smoke to escape, even after these changes.

FIGS. 14 and 15 illustrate cooking plate 16 which helps avoid fat flares which spoil the taste of the food and burn the food. The fat stays on the plate and the barbecue stays clean. Cooking plate 16 can also hold enough water which starts boiling and increases humidity within the barbecue.

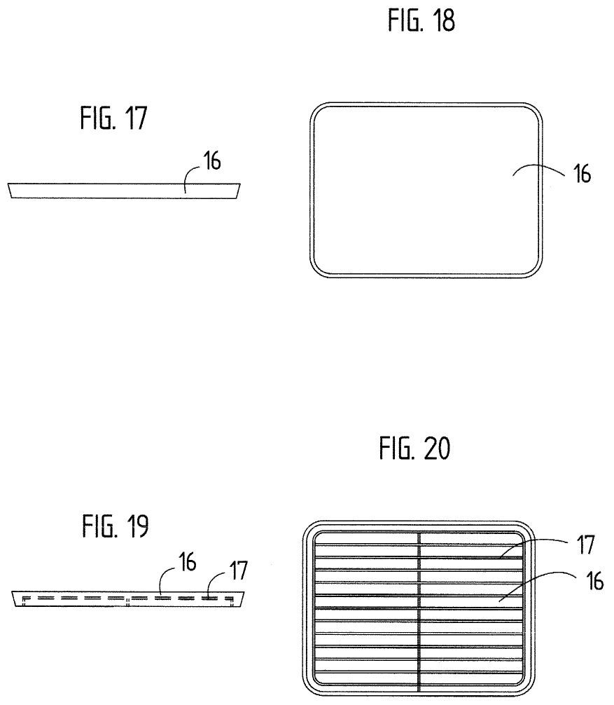

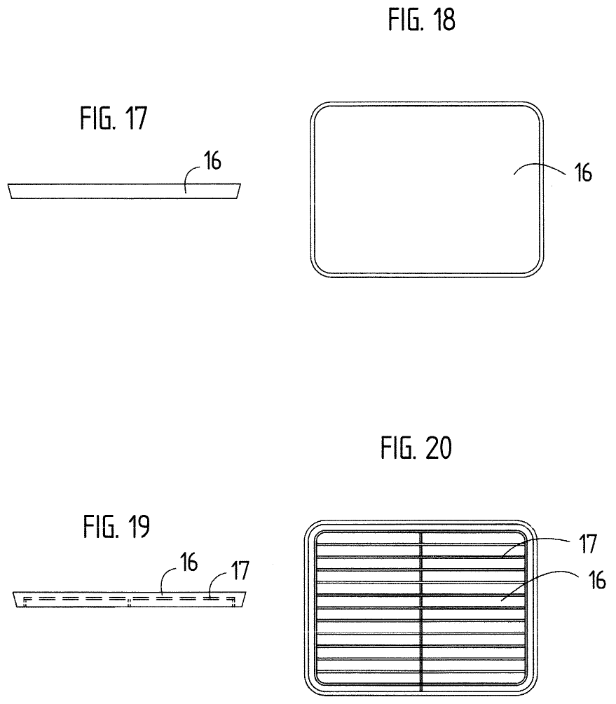

FIGS. 16 and 17 illustrate cooking plate 16 and grille 17. Cooking plate 16 helps avoid fat flares which spoil the taste of the food. The fat stays on the plate and the barbecue stays clean. Cooking grille 17 on cooking plate 16 can be used to make smoking of the food more efficient on all sides.

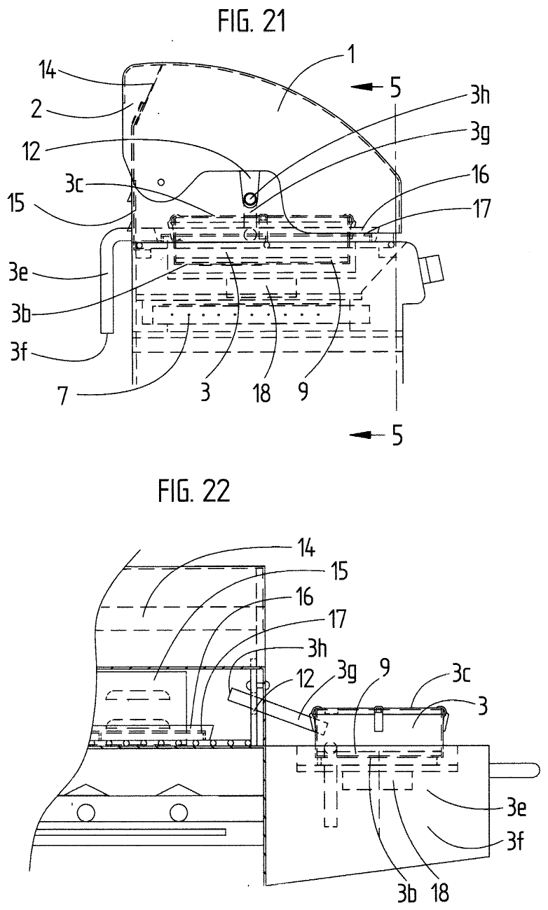

FIGS. 18 and 19 illustrate how smoker box 3 in FIG. 3 filled with wood 9 is used in indirect smoking. Smoker box 3 will be placed on or near the top of the adjacent gas burner of cooker 18 so that part 3g having the smoke outlet opening 3h goes through opening 12 in the side wall of the barbecue. This opening 12 is available for supporting a skewer. Outlet opening 3h is high above burners 7 and there is no risk of auto-ignition. Also, the air inlet opening 3f is outside of the barbecue in a lower and cooler place avoiding auto-ignition and ensuring a good draft. This embodiment can be used for smoking food without cooking it in high temperatures, for example, in cold smoking.

FIGS. 18 and 19 illustrate also how for quick fastening ventilation shutter 14 will be fixed to the inclined part of the back plate of body 10. It will reduce smoke escape in gap 2 to thicken the smoke under lid 1.

FIGS. 18 and 19 illustrate also how ventilation shutter 15 will be installed to reduce smoke escape through ventilation holes 4 to thicken the smoke under lid 1. For quick fastening, the shorter side of shutter 15 will be left under the edge of cooking grate 5 and the longer side covers the ventilation holes 4.

### OTHER EMBODIMENTS

FIGS. 7, 9, and 19 show positions and embodiments

of smoker box 3 and how part 3e is fixed to container 3a and part 3g to cover 3g, but several other positions and embodiments of smoker box 3 produce the same desired outcome.

It is clear to a person skilled in the art that
1. Part 3e can be a removable or fixed part or protrusion of container 3a or cover 3c and part 3g can be a removable or fixed part or protrusion of cover 3c or container 3a.
2. Cover 3c can be on any side of container 3a and covers at least part of one side or several sides of container 3a.
3. The shape and size of smoker box 3 is not limited except for practicality. The shape can be, including but not limited to, a prism, a cylinder, a cone, or a ball.
4. Smoker box 3 must be sufficiently tight to prevent smoke from escaping from the wrong place and igniting. It may be good that smoker box 3 has some kind of opening and a cover 3c for adding wood and removing charred wood, but it is not a must. Openings 3f and 3h can be used for filling and emptying smoker box 3 as shown in FIGS. 4 and 5. Smoker box 3 must have at least two openings but they can be also groups of openings: one 3f for air intake at a suitable location and the other 3h for smoke exhaust at a suitable higher location to create a sufficient draft in smoker box 3.
5. The cover 3c can be, including but not limited to, removable, hinged, or sliding, and the heat-resistant fasteners are freely selectable.
6. Smoker box 3 can be long enough to reach the top of several burners 7, in which case the smoking time can be extended by using one burner 7 at a time to char the wood on top to produce smoke. In this embodiment the smoke outlet opening 3g can be below the cooking grate 5 because burner 7 can be far enough and the air inlet opening 3f can also be on a little higher level, but still below the highest point of burner 7.
7. The direction and height of the outcoming smoke from the smoke outlet opening 3h can be adjustable and changed. For example, two nested round tubes can be used. The same method can be used in adjusting the height of the air inlet opening 3f. Parts 3e and 3g can be also armor tubes especially when air or smoke goes in the barbecue like in FIGS. 9 and 19.
8. The free cross area of the air inlet opening 3f and/or the smoke outlet opening 3h can be adjustable to ensure flow in the air inlet opening 3f only inward the smoker box.
9. Smoker box 3 can be so high that the top having the smoke outlet opening 3h is without any extension in a place where both the edges of the smoke outlet opening 3h and the ambient temperature are below the auto-ignition temperature of the smoke.
10. Smoker box 3 can also be used on cooking grate 5 within the barbecue, assuming smoker box 3 gets hot enough and smoke is produced. The air inlet opening 3f stays in the original lower level, lower than the highest point of burner 7, and in a charcoal barbecue lower than the charcoals.
11. Smoker box 3 in FIGS. 1 and 2 can be used in a charcoal barbecue when part 3e reaches under the charcoal and the air inlet opening 3f is located there.
12. Bottom 3b of smoker box 3 can slope down towards the air inlet opening 3h to guide the hot air flow away from the air inlet opening 3f so that smoke does not flare up in the air inlet opening 3f.

1. A compact smoker box adapted for receiving and enclosing smoke-producing woodchips therein through an air inlet opening or a smoke outlet opening and stands on its bottom on or near the top of a gas burner or charcoals within a barbecue or outside of the barbecue on or near the top of the gas burner of a cooker comprising
a container having its bottom, at least one air inlet opening, and at least one smoke outlet opening characterized in that at least one air inlet opening is located lower than the bottom of the container.

2. A compact smoker box adapted for receiving and enclosing smoke-producing woodchips therein through an air inlet opening or a smoke outlet opening and stands on its bottom on or near the top of a gas burner or charcoals within a barbecue or outside of the barbecue on or near the top of the gas burner of a cooker comprising
a container having its bottom, at least one air inlet opening having the edges connected to the container, and at least one smoke outlet opening having the edges connected to the container characterized in that the edges of at least one air inlet opening are located lower than the bottom of the container.

3. A compact smoker box adapted for receiving and enclosing smoke-producing woodchips therein through an air inlet opening or a smoke outlet opening and stands on its bottom on or near the top of a gas burner or charcoals within a barbecue or outside of the barbecue on or near the top of the gas burner of a cooker comprising
a container, adapted for receiving and holding a mass of wood-chips, and a cover that is adapted for opening and closing the container, when the smoker box is open the cover permitting a mass of woodchips to be placed in the container, and at least one air inlet opening having the edges connected, either to the container or to the cover, and at least one smoke outlet opening having the edges connected, either to the cover or the container characterized in that the edges of at least one air inlet opening are located lower than the bottom of the container.

4. A smoker box according to claims 1 or 2 characterized in that it doesn't have any other opening in addition to a group of air inlet openings and a group of smoke outlet openings.

5. A smoker box according to claims 1 or 2 characterized in that it has a cover adapted for opening and closing the container.

6. A smoker box according to claims 1, 2 or 3 characterized in that at least one air inlet opening is at least 1 inch lower than the bottom of the container when the container is standing on its bottom.

7. A smoker box according to claims 1, 2 or 3 characterized in that the smoke outlet opening is located at the highest level of all parts of the smoker box.

8. A smoker box according to claims 1, 2 or 3 characterized in that the smoke outlet opening is located within the barbecue above the cooking grate at the highest level of all parts of the smoker box.

9. A smoker box according to claims 1 2, or 3 characterized in that the smoke goes in the barbecue from the smoker box, heated on or near the top of the burner of an adjacent gas cooker outside the barbecue.

10. A smoker box according to claims 1, 2, or 3 characterized in that the smoker box located within a barbecue has its air inlet opening outside of the barbecue.

11. A smoker box according to claims 1, 2, or 3 characterized in that the direction and height of the outcoming smoke from the smoke outlet opening and the height of the air inlet opening are adjustable.

12. A smoker box according to claims 1, 2, or 3 characterized in that the free cross area of the smoke outlet opening is bigger than the free cross area of the air inlet opening or it is adjustable.

13. A smoker box according to claims 1, 2, or 3 characterized in that the position of the air inlet opening of the smoker box is suitable for placing it in the ventilation opening which brings fresh air to the barbecue.

14. A smoker box according to claims 1, 2, or 3 characterized in that the bottom of the smoker box slopes down towards the air inlet opening of the smoker box.

15. A smoker box according to claims 1, 2, or 3 characterized in that the smoker box within the barbecue is used on the cooking grate and at least one air inlet opening is below the burners.

16. A smoker box according to claims 1, 2, or 3 characterized in that the smoker box is long enough to reach the top of several burners.

17. A smoker box according to claims 1, 2, or 3 characterized in that ventilation shutter 14 is used in closing air gap 2 and/or ventilation shutter 15 is used to cover ventilation holes 4, both to thicken the smoke within the barbecue.

18. A smoker box according to claim 1, 2 or 3, characterized in that the air inlet opening is below the charcoal grate within the barbecue.

19. A smoker box according to claims 1, 2, or 3 characterized in that the smoke outlet opening is below the auto-ignition temperature of the smoke coming out from the smoker box.

20. A smoker box according to claims 1, 2, or 3, characterized in that cooking plate 16 is used to help avoid fat flares.
